(19) United States
(12) Patent Application Publication
(10) Pub. No.: US 2020/0140674 A1
(43) Pub. Date: May 7, 2020

(54) RUBBER COMPOSITION AND PNEUMATIC TIRE CONTAINING BENZOFULVENE COPOLYMER

(71) Applicant: The Goodyear Tire & Rubber Company, Akron, OH (US)

(72) Inventors: William Paul FRANCIK, Bath, OH (US); Derek SHUTTLEWORTH, Medina, OH (US)

(21) Appl. No.: 16/180,074

(22) Filed: Nov. 5, 2018

(51) Int. Cl. C08L 53/02; C08L 9/06; C08L 7/00; C08F 232/08; C08F 236/08; C08K 3/04; C08K 3/36; B60C 1/00

(52) U.S. Cl. CPC C08L 53/02; C08L 9/06; C08L 7/00; C08F 232/08; B60C 1/0025; C08K 3/04; C08K 3/36; B60C 1/0016; C08F 236/08

(57) ABSTRACT

The invention is directed to a rubber composition comprising a block copolymer of a conjugated diene monomer and benzofulvene, and a pneumatic tire comprising the rubber composition.

### BACKGROUND

There is interest in utilizing synthetic polymer particles as reinforcement in tire rubber compounds in place of traditional fillers, such as carbon black and silica. Such synthetic fillers may include nylon, polyaramid, syndiotactic polybutadiene, and various block copolymers. There are at least two problems generic to all of these approaches. First, the T_{g} of the reinforcing polymer particles has to be high enough so that the particles do not soften at the operating temperature of the tires (T_{g}>110-120° C.). At the same time, the melting temperature should be low enough so the particles melt during mixing (Tₘ<170° C.), or the particles be made of small enough particle size. Second, the cost of most of these reinforcing materials is too high.

### SUMMARY

There is disclosed a rubber composition comprising a block copolymer of a conjugated diene monomer and benzofulvene, and a pneumatic tire comprising the rubber composition.

### DESCRIPTION

The present invention is directed to a rubber composition comprising a block copolymer of a conjugated diene monomer and benzofulvene, and a pneumatic tire comprising the rubber composition.

The block copolymer is a copolymer of a conjugated diene monomer and benzofulvene:

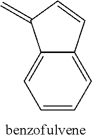

The block copolymer may be synthesized for example by anionic solution polymerization using a lithium catalyst. Further reference may be made to Weiyu Wang, “Novel Thermoplastic Elastomers based on Benzofulvene: Synthesis and Mechanical Properties”, PhD dissertation, University of Tennessee, 2015, available at trace.tennessee.edu/utk_graddiss/3558.

In one embodiment, the block copolymer is a diblock copolymer having the structure polyA-b-polyB where A is a residue of benzofulvene, B is a residue of a conjugated diene monomer.

In one embodiment, the block copolymer is a triblock copolymer having the structure polyA-b-polyB-b-polyA where A is a residue of benzofulvene, and B is a residue of a conjugated diene monomer.

In one embodiment, the monomers used to synthesize the block copolymer include a conjugated diene monomer and benzofulvene.

Suitable conjugated diene monomers include 1,3-butadiene, isoprene, 1,3-pentadiene, 2,3-dimethyl-1,3-butadiene, 2-methyl-1,3-pentadiene, 2,3-dimethyl-1,3-pentadiene, 2-phenyl-1,3-butadiene, and 4,5-diethyl-1,3-octadiene, and the like. In one embodiment the conjugated diene monomer is 1,3 butadiene or isoprene. In one embodiment the conjugated diene monomer is isoprene.

In one embodiment, the block copolymer includes from 60 to 90 percent by weight of a polyB (polydiene) block, and from 10 to 40 percent by weight of a polyA (polybenzofulvene) block. In one embodiment, the block copolymer includes from 70 to 80 percent by weight of a polydiene block, and 20 to 30 percent by weight of a polybenzofulvene block.

The copolymer will exhibit two glass transition temperatures in a DSC trace, one corresponding to the polydiene block and one corresponding to the polybenzofulvene block. The Tg of the polydiene block with be in a range typical from polybutadiene, generally from −85 to −105° C. The Tg of the polybenzofulvene block will be about 145° C. Glass transition temperature may be measured for example by DSC inflection with a 10-20° C./min heating rate.

The copolymer of the invention may be compounded into a rubber composition.

The rubber composition may optionally include, in addition to the copolymer, one or more rubbers or elastomers containing olefinic unsaturation. The phrases “rubber or elastomer containing olefinic unsaturation” or “diene based elastomer” are intended to include both natural rubber and its various raw and reclaim forms as well as various synthetic rubbers. In the description of this invention, the terms “rubber” and “elastomer” may be used interchangeably, unless otherwise prescribed. The terms “rubber composition,” “compounded rubber” and “rubber compound” are used interchangeably to refer to rubber which has been blended or mixed with various ingredients and materials and such terms are well known to those having skill in the rubber mixing or rubber compounding art. Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile (which polymerize with butadiene to form NBR), methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether. Specific examples of synthetic rubbers include neoprene (polychloroprene), polybutadiene (including cis-1,4-polybutadiene), polyisoprene (including cis-1,4-polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers. The preferred rubber or elastomers are polyisoprene (natural or synthetic), polybutadiene and SBR.

In one aspect the at least one additional rubber is preferably of at least two of diene-based rubbers. For example, a combination of two or more rubbers is preferred such as cis 1,4-polyisoprene rubber (natural or synthetic, although natural is preferred), 3,4-polyisoprene rubber, styrene/isoprene/butadiene rubber, emulsion and solution polymerization derived styrene/butadiene rubbers, cis 1,4-polybutadiene rubbers and emulsion polymerization prepared butadiene/acrylonitrile copolymers.

In one aspect of this invention, an emulsion polymerization derived styrene/butadiene (E-SBR) might be used having a relatively conventional styrene content of about 20 to about 28 percent bound styrene or, for some applications, an E-SBR having a medium to relatively high bound styrene content, namely, a bound styrene content of about 30 to about 45 percent.

By emulsion polymerization prepared E-SBR, it is meant that styrene and 1,3-butadiene are copolymerized as an aqueous emulsion. Such are well known to those skilled in such art. The bound styrene content can vary, for example, from about 5 to about 50 percent. In one aspect, the E-SBR may also contain acrylonitrile to form a terpolymer rubber, as E-SBAR, in amounts, for example, of about 2 to about 30 weight percent bound acrylonitrile in the terpolymer.

Emulsion polymerization prepared styrene/butadiene/acrylonitrile copolymer rubbers containing about 2 to about 40 weight percent bound acrylonitrile in the copolymer are also contemplated as diene based rubbers for use in this invention.

The solution polymerization prepared SBR (S-SBR) typically has a bound styrene content in a range of about 5 to about 50, preferably about 9 to about 36, percent. The S-SBR can be conveniently prepared, for example, by organo lithium catalyzation in the presence of an organic hydrocarbon solvent.

In one embodiment, cis 1,4-polybutadiene rubber (BR) may be used. Such BR can be prepared, for example, by organic solution polymerization of 1,3-butadiene. The BR may be conveniently characterized, for example, by having at least a 90 percent cis 1,4-content.

The cis 1,4-polyisoprene and cis 1,4-polyisoprene natural rubber are well known to those having skill in the rubber art.

In embodiments where an additional elastomer is used, the rubber composition may comprise from 10 to 90 phr of the block copolymer, and from 90 to 10 phr of the additional elastomer.

The term “phr” as used herein, and according to conventional practice, refers to “parts by weight of a respective material per 100 parts by weight of rubber, or elastomer.”

The rubber composition may also include up to 70 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. Suitable process oils include various oils as are known in the art, including aromatic, paraffinic, naphthenic, vegetable oils, and low PCA oils, such as MES, TDAE, SRAE and heavy naphthenic oils. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

The rubber composition may include from about 10 to about 150 phr of silica. In another embodiment, from 20 to 100 phr of silica may be used.

The commonly employed siliceous pigments which may be used in the rubber compound include conventional pyrogenic and precipitated siliceous pigments (silica). In one embodiment, precipitated silica is used. The conventional siliceous pigments employed in this invention are precipitated silicas such as, for example, those obtained by the acidification of a soluble silicate, e.g., sodium silicate.

Such conventional silicas might be characterized, for example, by having a BET surface area, as measured using nitrogen gas. In one embodiment, the BET surface area may be in the range of about 40 to about 600 square meters per gram. In another embodiment, the BET surface area may be in a range of about 80 to about 300 square meters per gram. The BET method of measuring surface area is described in the Journal of the American Chemical Society, Volume 60, Page 304 (1930).

The conventional silica may also be characterized by having a dibutylphthalate (DBP) absorption value in a range of about 100 to about 400, alternatively about 150 to about 300.

The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, etc; silicas available from Rhodia, with, for example, designations of Z1165MP and Z165GR and silicas available from Degussa AG with, for example, designations VN2 and VN3, etc.

Commonly employed carbon blacks can be used as a conventional filler in an amount ranging from 10 to 150 phr. In another embodiment, from 20 to 100 phr of carbon black may be used. Representative examples of such carbon blacks include N110, N121, N134, N220, N231, N234, N242, N293, N299, N315, N326, N330, N332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

Other fillers may be used in the rubber composition including, but not limited to, particulate fillers including ultra-high molecular weight polyethylene (UHMWPE), crosslinked particulate polymer gels including but not limited to those disclosed in U.S. Pat. No. 6,242,534; 6,207,757; 6,133,364; 6,372,857; 5,395,891; or 6,127,488, and plasticized starch composite filler including but not limited to that disclosed in U.S. Pat. No. 5,672,639. Such other fillers may be used in an amount ranging from 1 to 30 phr.

In one embodiment the rubber composition may contain a conventional sulfur containing organosilicon compound. In one embodiment, the sulfur containing organosilicon compounds are the 3,3′-bis(trimethoxy or triethoxy silylpropyl) polysulfides. In one embodiment, the sulfur containing organosilicon compounds are 3,3′-bis(triethoxysilylpropyl) disulfide and/or 3,3′-bis(triethoxysilylpropyl) tetrasulfide.

In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from Momentive Performance Materials.

In another embodiment, suitable sulfur containing organosilicon compounds include those disclosed in U.S. Patent Publication No. 2003/0130535. In one embodiment, the sulfur containing organosilicon compound is Si-363 from Degussa.

The amount of the sulfur containing organosilicon compound in a rubber composition will vary depending on the level of other additives that are used. Generally speaking, the amount of the compound will range from 0.5 to 20 phr. In one embodiment, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may be used in an amount ranging from 0.5 to 8 phr, alternatively with a range of from 1.5 to 6 phr. Typical amounts of tackifier resins, if used, comprise about 0.5 to about 10 phr, usually about 1 to about 5 phr. Typical amounts of processing aids comprise about 1 to about 50 phr. Typical amounts of antioxidants comprise about 1 to about 5 phr. Representative antioxidants may be, for example, diphenyl-p-phenylenediamine and others, such as, for example, those disclosed in The Vanderbilt Rubber Handbook (1978), Pages 344 through 346. Typical amounts of antiozonants comprise about 1 to 5 phr. Typical amounts of fatty acids, if used, which can include stearic acid comprise about 0.5 to about 3 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 4, alternatively about 0.8 to about 1.5, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be a guanidine, dithiocarbamate or thiuram compound.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

The rubber composition may be incorporated in a variety of rubber components of the tire. For example, the rubber component may be a tread (including tread cap and tread base), sidewall, apex, chafer, sidewall insert, wirecoat or innerliner. In one embodiment, the component is a tread.

The pneumatic tire of the present invention may be a race tire, passenger tire, aircraft tire, agricultural, earthmover, off-the-road, truck tire, and the like. In one embodiment, the tire is a passenger or truck tire. The tire may also be a radial or bias.

Vulcanization of the pneumatic tire of the present invention is generally carried out at conventional temperatures ranging from about 100° C. to 200° C. In one embodiment, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

This invention is illustrated by the following examples that are merely for the purpose of illustration and are not to be regarded as limiting the scope of the invention or the manner in which it can be practiced. Unless specifically indicated otherwise, parts and percentages are given by weight.

### Example 1

### Synthesis and Characterization of Experimental Copolymers

The polymers are prepared by living anionic polymerization as in the following scheme (see Weiyu Wang, “Novel Thermoplastic Elastomers based on Benzofulvene: Synthesis and Mechanical Properties”, PhD dissertation, University of Tennessee, 2015, available at trace.tennessee.edu/utk_graddiss/3558.)

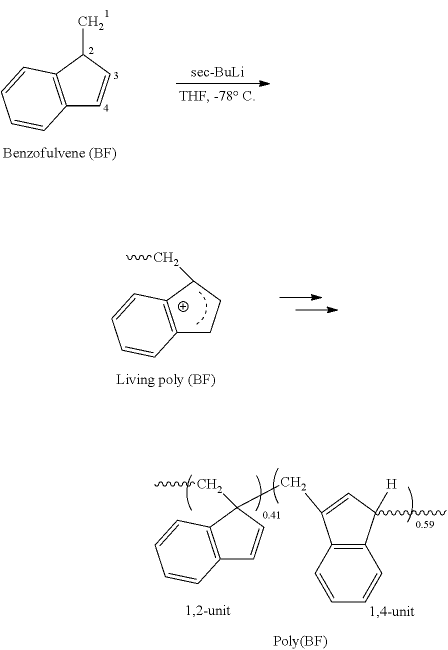

Two polymers containing 20 wt % of the benzofulvene were prepared. Table 1 below shows the description and characterization of the polymers. Analogous styrene-isoprene diblock and triblock polymers were also prepared for comparison.

TABLE 1

| | | Composition | Molecular Weight | | |
|---|---|---|---|---|---|
| Polymer | Composition | by NMR | Mₙ | M_{w} | MWD |
| PI | — | — | 116.0 | 125.0 | 1.08 |
| PBf-b-PI | 20-80 | 17.2/82.8 | 162.0 | 166.4 | 1.03 |
| | (Homo PI) | | 132.1 | 135.2 | 1.02 |
| PBf-b-PI-b- | 10-80-10 | 18.7/81.3 | 151.0 | 182.3 | 1.21 |
| PBf | (Homo PI) | | 119.0 | 139.2 | 1.17 |

### Example 2

The copolymers of Example 1 were evaluated in a model RMT tread compound consisting of 100 phr of PI and 55 phr of carbon black (shown in Table 2). The experimental compounds replaced 10 phr of carbon black with approximately 18 phr of thermoplastic (as an example, the diblock Bf-I copolymer is shown in Table 2, 90 phr of copolymer contains 18 phr polybenzofulvene thermoplastic block). In order to compare the compounds, a similar polymer matrix was required, such that the control compound contained the same level and type of PI used in the synthesis of the block copolymers.

TABLE 2

Sample No.

| | 1 | 2 |
|---|---|---|
| Polyisoprene | 28 | 100 |
| PBf-b-PI | 90 | 0 |
| Carbon Black | 45 | 55 |
| Zinc Oxide | 3 | 3 |
| Stearic Acid | 2 | 2 |
| Antidegradants | 4.5 | 4.5 |
| Sulfur | 1 | 1 |
| Accelerator | 1.5 | 1.5 |

The compounds were mixed in a 60 cc Haake mixer. The rotor speed and body temperature were adjusted in order to obtain approximately 4 min of mixing time and 160 drop temperature with the last minute of mixing being held between 150-160 deg. C. This was required in order to assure the melting of the PBF block segment to improve the incorporation and dispersion of the ingredients. A second nonproductive step was done with a drop temperature of 150 C for approximately 3 min of mixing, and the productive mixing stage was dropped at normal temperatures, approximately 105 C.

The compounds were tested for various physical properties, with results for diblock polymers shown in Table 3 and results for triblock polymers shown in Table 4.

TABLE 3

| | Sample No. | | |
|---|---|---|---|
| | 3 | 4 | 5 |
| | Polymer | | |
| | PS-b-PI¹ | PBf-b-PI² | PI³ |
| Carbon Black | 45 | 45 | 55 |
| PHR Thermoplastic | 18 | 18 | 0 |
| MDR (150 C.) | | | |
| Min Torque | 1.2 | 1.7 | 1.7 |
| T25, min | 11.4 | 12.1 | 6 |
| T90, min | 16.7 | 17.6 | 9.5 |
| Delta Torque | 8.3 | 15.8 | 17.9 |
| Tensile Properties | | | |
| 25% Modulus, MPa | 1.2 | 1.8 | 1.2 |
| 100% Modulus, MPa | 2.6 | 2.9 | 2.4 |
| 300% Modulus, MPa | 10.4 | 10.1 | 10.2 |
| Tensile Strength, MPa | 18.2 | 23 | 21 |
| Elongation at Break, % | 608 | 604 | 563 |
| RPA (100 C.) | | | |
| G′ Uncured, 15% strain, MPa | 321 | 284 | 180 |
| G′ 1%, MPa | 1.27 | 1.96 | 3.2 |
| G′ 10%, MPa | 1.14 | 1.55 | 1.66 |
| Tan delta 10% | 0.104 | 0.087 | 0.174 |
| G′ 50%, MPa | 0.91 | 1.05 | 1.07 |

¹styrene-isoprene diblock copolymer from Example 2
²benzofulvene-isoprene diblock copolymer from Example 2
³polyisoprene homopolymer from Example 2

TABLE 4

| | Sample No. | | | |
|---|---|---|---|---|
| | 6 | 7 | 8 | 9 |
| | Polymer | | | |
| | PS-b-PI- | PBf-b-PI- | PBf-b- | |
| | b-PS¹ | b-PBf² | PI³ | PI⁴ |
| Carbon Black | 45 | 45 | 45 | 55 |
| PHR Thermoplastic | 18 | 18 | 18 | 0 |
| MDR (150 C.) | | | | |
| Min Torque | 2 | 2.1 | 1.7 | 1.7 |
| T25, min | 11.3 | 10.6 | 12.1 | 6 |
| T90, min | 16.8 | 15.6 | 17.6 | 9.5 |
| Delta Torque | 6.6 | 10.6 | 15.8 | 17.9 |
| Tensile Properties | | | | |
| 25% Modulus, MPa | 1.2 | 0.9 | 1.8 | 1.2 |
| 300% Modulus, MPa | 9.2 | 10.9 | 10.1 | 10.2 |
| Tensile Strength, MPa | 19.6 | 22.3 | 23 | 21 |
| Elongation at Break, % | 711 | 538 | 604 | 563 |
| RPA (100 C.) | | | | |
| G′ Uncured, 15% strain, MPa | 470 | 370 | 284 | 180 |
| G′ 1%, MPa | 1.2 | 1.3 | 1.96 | 3.2 |
| G′ 10%, MPa | 1.9 | 1.1 | 1.55 | 1.66 |
| Tan delta 10% | 0.146 | 0.052 | 0.087 | 0.174 |
| G′ 50%, MPa | 0.74 | 0.95 | 1.05 | 1.07 |

¹styrene-isoprene triblock copolymer from Example 2
²benzofulvene-isoprene triblock copolymer from Example 2
³benzofulvene-isoprene diblock copolymer from Example 2
⁴polyisoprene homopolymer from Example 2

What is claimed is:

1. A rubber composition comprising a block copolymer of a conjugated diene monomer and benzofulvene.

2. The rubber composition of claim 1, further comprising a filler selected from the group consisting of silica and carbon black.

3. The rubber composition of claim 1, wherein the conjugated diene monomer is selected from the group consisting of isoprene and butadiene.

4. The rubber composition of claim 1, further comprising at least one additional elastomer.

5. The rubber composition of claim 1, further comprising at least one additional elastomer selected from the group consisting of polybutadienes, styrene-butadiene rubbers, natural rubbers, and synthetic polyisoprenes.

6. The rubber composition of claim 1, wherein the copolymer is a diblock copolymer A-B and wherein A is a polybenzofulvene block and B is a conjugated diene polymer block.

7. The rubber composition of claim 1, wherein the copolymer is a triblock copolymer A-B-A and wherein A is a polybenzofulvene block and B is a conjugated diene polymer block.

8. The rubber composition of claim 1, wherein the copolymer comprising from 10 to 40 percent by weight of benzofulvene monomer units and 60 to 90 percent by weight of conjugated diene monomer units.

9. The rubber composition of claim 1, wherein the copolymer comprising from 20 to 30 percent by weight of benzofulvene monomer units and 70 to 80 percent by weight of conjugated diene monomer units.

10. A pneumatic tire comprising the rubber composition of claim 1.
